(19) United States
(12) Patent Application Publication
(10) Pub. No.: US 2023/0071886 A1
(43) Pub. Date: Mar. 9, 2023

(54) PERFORMANCE SYSTEM FOR FORECASTING FEATURE DEGRADATIONS

(71) Applicant: salesforce.com, inc., San Francisco, CA (US)

(72) Inventor: Christopher Delgado, San Francisco, CA (US)

(21) Appl. No.: 17/467,707

(22) Filed: Sep. 7, 2021

(51) Int. Cl. G06Q 30/02; G06Q 10/06; G06Q 30/00; G06Q 10/10

(52) U.S. Cl. CPC G06Q 30/0202; G06Q 10/1093; G06Q 10/06393; G06Q 30/016; G06Q 30/0201

(57) ABSTRACT

Methods, computer readable media, and devices for predicting future performance degradation are disclosed. One method may include collecting metadata associated with a plurality of features utilized by a plurality of customers, identifying a set of metrics indicating performance of at least one feature, identifying and transforming a subset of metadata based on the set of metrics, identifying a data model based on the set of metrics, applying the data model to the subset of metadata to predict future performance of at least one feature for at least one customer, and, in response to predicting future performance of at least one feature for at least one customer exceeds a threshold, generating an alert indicating the at least one customer may experience performance degradation of the at least one feature.

### TECHNICAL FIELD

Embodiments disclosed herein relate to techniques and systems for predicting future performance degradations affecting specific services and specific customers based on metadata associated with services.

### BACKGROUND

In a traditional approach, monitoring of overall hardware and capacity may be performed and general system performance may be evaluated. However, in a multi-tenant environment where multiple customers share the same hardware and multiple features share the same execution environment, diagnosing and predicting, for a particular customer using a particular feature, performance degradation may be challenging.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1 is a block diagram illustrating a system for predicting future performance degradation according to some example implementations.

FIG. 2 is a flow diagram illustrating a method for predicting future performance degradation according to some example implementations.

FIG. 3A is a block diagram illustrating an electronic device according to some example implementations.

FIG. 3B is a block diagram of a deployment environment according to some example implementations.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Embodiments disclosed herein provide techniques and systems for predicting performance degradation affecting specific services and specific customers based on metadata associated with various services. In particular, disclosed embodiments may enable prediction of future performance issues of a particular service for a particular customer based on historical performance of the service for various customers.

In various implementations, metadata associated with a plurality of features may be collected in a raw format. A feature may be a service or other functionality provided by a computing platform, such as a customer relationship management (CRM) platform. The computing platform may be utilized by a plurality of customers where each customer may be an organization with multiple individuals using the platform. As such, metadata associated with an individual feature may describe interactions of various individuals across multiple organizations. For example, when a first individual utilizes a first feature, that first interaction may be recorded as a logline including various details about that first interaction. Similarly, when a second individual utilizes the first feature, that second interaction may also be recorded as a logline including various details about that second interaction. In addition, when the first individual utilizes a second feature, that third interaction may be record as a logline including various details about that third interaction. Of note, while the first and second loglines may include similar details specific to the first feature, the third logline may include different details specific to the second feature.

In one example, a set of metrics may be identified for a particular feature. Metrics may include, for example, an average transaction age, time preparing a transaction, time processing a transaction, a completed task status, a number of requests triggered, and the like. Of note, while some metrics may be applicable to one feature, another feature may have a different set of applicable metrics. As such, the set of metrics may be specific to the particular feature. The set of metrics may, for example, be indicative of performance of the particular feature for at least one of a plurality of customers.

In this one example, a subset of metadata may be identified and transformed based on the identified set of metrics. For example, loglines generated as a result of interactions with the particular feature may be selected or otherwise retrieved from the collection of metadata. In addition, the identified loglines may be transformed, for example, by preserving some details of the identified loglines while eliminating other details from the identified loglines. As a result of this identification and transformation, the subset of metadata may include, for example, only those details relevant to evaluating the identified set of metrics.

Further in this one example, a data model may be identified based on the identified set of metrics and the identified data model may be applied to the subset of metadata to predict a future performance of the feature for at least one of the plurality of customers. The data model may be, for example, an open source data model, a customized data model, a third-party derived data model, or the like. The predicted future performance may, for example, be compared to a threshold or other criteria in order to identify or otherwise indicate a potential for future performance degradation of the feature. If future performance degradation is identified, an alert or other identification may be generated.

Implementations of the disclosed subject matter provide methods, computer readable media, and devices for predicting future performance degradation of a feature utilized by a customer. In various implementations, a method for predicting future performance degradation of at least one of a plurality of features utilized by at least one of a plurality of customers may include collecting, in a raw format, metadata associated with a plurality of features utilized by a plurality of customers, identifying, for at least one feature, a set of metrics indicating performance of the at least one feature, identifying and transforming, based on the set of metrics, a subset of metadata, identifying, based on the set of metrics, a data model, applying the data model to the subset of metadata to predict future performance of the at least one feature for at least one of the plurality of customers, and, in response to predicting future performance of the at least one feature for at least one of the plurality of customers exceeds a threshold, generating an alert indicating the at least one of the plurality of customers may experience performance degradation of the at least one feature. In some implementations, the metadata may include a plurality of loglines and at least one logline may be associated with an execution of a feature by a customer including metrics associated with the execution.

In some implementations, the plurality of features may include calendar sync, high velocity sales, territory management, forecasting, and the like.

In some implementations, the set of metrics may include an average transaction age, a time preparing a transaction, a time processing a transaction, a completed task status, a number of requests triggered per time period, and the like.

In some implementations, the data model may be an open source data model, a customized data model, a third-party derived data model, or the like.

In various implementations, identifying and transforming, based on the set of metrics, the subset of metadata may include identifying the subset of metadata to include one or more loglines, the one or more loglines including one or more metrics of the set of metrics and transforming the subset of metadata such that the one or more loglines may include the set of metrics and an indication of an associated customer.

In some implementations, the method may further include identifying, for at least one other feature, a second set of metrics indicating performance of the at least one other feature, identifying and transforming, based on the second set of metrics, a second subset of metadata, identifying, based on the second set of metrics, a second data model, applying the second data model to the second subset of metadata to predict future performance of the at least one other feature for at least one of the plurality of customers, and, in response to predicting future performance of the at least one other feature for at least one of the plurality of customers exceeds a threshold, generating an alert indicating the at least one of the plurality of customers may experience performance degradation of the at least one other feature.

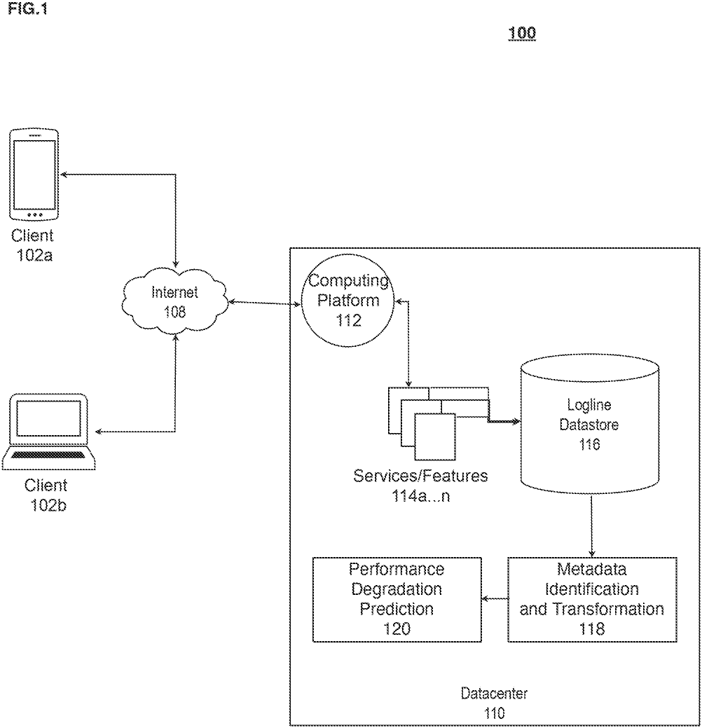

FIG. 1 illustrates a system 100 for predicting future performance degradation according to various implementations of the subject matter disclosed herein. In various implementations, users may interact with computing platform 112 and services/features 114a... n via the Internet 108 using clients 102a, 102b. Clients 102a, 102b may be, for example, a laptop, a computer, a mobile device, a tablet, and/or some other computing device. The users may be, for example, associated with one or more of a plurality of organizations. In some implementations, the plurality of organizations may be different from an organization providing computing platform 112 and/or services/features 114a... n. In various implementations, computing platform 112 may be, for example, a customer relationship management (CRM) platform, an enterprise resource planning (ERP) platform, an e-commerce platform, a database management platform, or some other computing platform. In various implementations, services/features 114a... n may include, for example, features and/or services provided by or through computing platform 112, such as calendar sync, sales management, territory management, forecast, and the like.

In various implementations, computing platform 112 and services/features 114a... n may, for example, be located within datacenter 110. Although computing platform 112 and service/features 114a...n are shown as single elements, this is only for simplicity. In some implementations, computing platform 112 may be, for example, a plurality of servers deployed in a distributed fashion and the plurality of servers may be located in a single datacenter and/or distributed across a plurality of datacenters. Similarly, services/features 114a... n may be located in the same as computing platform 112, may be located in a different datacenter, and/or may be distributed across a plurality of datacenters. In some implementations, computing platform 112 and services/features 114a... n may implement a single application and/or online environment, such as retail shopping, information retrieval, and/or relationship management. In some implementations, computing platform 112 and services/features 114a... n may implement a plurality of applications and/or online environments. That is, computing platform 112 and services/features 114a... n may be dedicated to a single solution or may be shared by multiple solutions.

In various implementations, services/features 114a... n may, for example, generate metadata associated with or otherwise describing interactions by users with services/features 114a... n. Such metadata may be stored, for example, in logline datastore 116. Logline datastore 116 may be, for example, a data store or other storage, such as a hard drive array, disk array, storage array, or the like. In some implementations, generated metadata may be stored in logline datastore 116 in a raw format. For example, a single interaction by a user with a single feature may generate several details about that single interaction and the various details may be stored as a single line of data commonly referred to as a logline. The various details may, for example, describe a performance of the feature during the single interaction. Since different features may generate different metadata describing different performance characteristics, one logline may include different details from another logline. That is, the various loglines are in a raw format because individual loglines may include different data.

In various implementations, metadata identification and transformation 118 may analyze performance of a particular service/feature by identifying a subset of metadata and transforming the subset of metadata into a structured format. For example, a set of metrics associated with a particular service/feature may be identified. The set of metrics may, for example, describe a performance of the particular feature for at least one organization. Of note, since one organization may include a plurality of users, the described performance may not necessarily be that of a single user, but rather that of various users across the organization. Of further note, while the set of metrics may be based on or otherwise utilize details stored within loglines associated with the particular feature, the set of metrics may not be based on or otherwise utilize all of the details of the associated loglines. As such, the identified subset of metadata may be not only a selection of loglines associated with the particular feature, but also a selection of specific details from the associated loglines. In turn, the identified subset of metadata may be transformed into a structured subset of metadata based on the identified set of metrics.

In various implementations, performance degradation prediction 120 may generate a prediction of future performance of a particular service/feature by identifying a data model and applying the data model to the identified and transformed subset of metadata. For example, a data model may be selected based on the identified set of metrics. The data model may be, for example, an open source data model, a customized data model, a third-party derived data model, or the like. By applying the data model to the subset of metadata, a future performance of the particular feature may be predicted. Such prediction may include, for example, an indicating of whether the future performance will exceed a threshold. If future performance is predicted to exceed the threshold, an alert may be generated indicating such performance degradation.

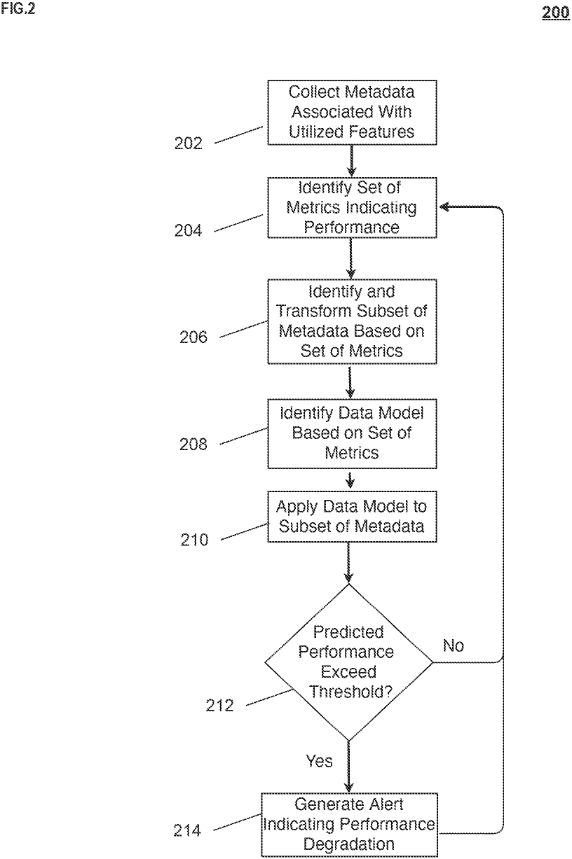

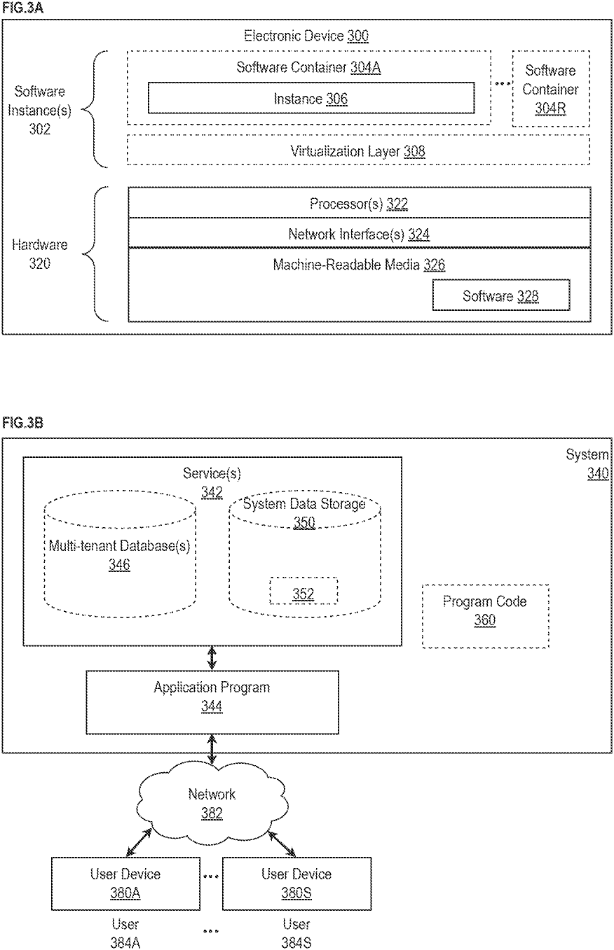

FIG. 2 illustrates a method 200 for predicting future performance degradation, as disclosed herein. In various implementations, the steps of method 200 may be performed by a server, such as electronic device 300 of FIG. 3A or system 340 of FIG. 3B, and/or by software executing on a server or distributed computing platform. Although the steps of method 200 are presented in a particular order, this is only for simplicity.

In step 202, metadata associated with utilized features may be collected. In various implementations, collected metadata may include, for example, details describing performance of at least one feature utilized by at least one organization. The metadata may be stored, for example, in a raw format. In some implementations, details associated with a single interaction of a feature may be stored, for example, in a line commonly referred to as a logline.

In step 204, a set of metrics indicating performance of a feature may be identified. In various implementations, the set of metrics may include, for example, one or more of an average transaction age, a time preparing a transaction, a time processing a transaction, a completed task status, a number of requests triggered per time period, or the like.

In step 206, a subset of metadata may be identified and transformed based on the set of metrics. In various implementations, the subset of metadata may include, for example, a selection of interactions of users with the at least one feature and a selection of details from the selection of interactions.

In step 208, a data model may be identified based on the set of metrics. In various implementations, the data model may be, for example, an open source data model, a customized data model, a third-party derived data model, or the like.

In step 210, the identified data model may be applied to the subset of metadata. In various implementations, the data model may be applied to the subset of metadata, for example, to predict a future performance of the at least one feature for at least one of a plurality of organizations. For example, applying the data model to the subset of metadata may generate a graph or other indication of historical performance as well as predicted future performance.

In determination step 212, a determination of whether the predicted future performance exceeds a threshold may be made. If predicted future performance is determined to not exceed a threshold (i.e., determination step 212 = “No”), the method may return to step 204 and another set of metrics may be identified.

If predicted future performance is determined to exceed a threshold (i.e., determination step 212 = “Yes”), an alert indicating performance degradation may be generated in step 214.

As disclosed herein, future performance degradation may be predicted. Such predictions of future performance degradation may enable proactive management of organizations and their interaction with individual features. Unlike a traditional approach of monitoring individual customers and/or services for current performance issues and reacting to problems, the disclosed subject matter enables predicting future performance of a particular feature for a particular customer by analyzing a large amount of data collected across a plurality of features and a plurality of organizations. Such analysis of large data sets necessarily requires use of computing resources and the analysis disclosed herein enables improved utilization of those computing resources as well as improved performance of features provided to organizations.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals - such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program’s inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

FIG. 3A is a block diagram illustrating an electronic device 300 according to some example implementations. FIG. 3A includes hardware 320 comprising a set of one or more processor(s) 322, a set of one or more network interfaces 324 (wireless and/or wired), and machine-readable media 326 having stored therein software 328 (which includes instructions executable by the set of one or more processor(s) 322). The machine-readable media 326 may include non-transitory and/or transitory machine-readable media. Each of the previously described clients and consolidated order manager may be implemented in one or more electronic devices 300.

During operation, an instance of the software 328 (illustrated as instance 306 and referred to as a software instance; and in the more specific case of an application, as an application instance) is executed. In electronic devices that use compute virtualization, the set of one or more processor(s) 322 typically execute software to instantiate a virtualization layer 308 and one or more software container(s) 304A-304R (e.g., with operating system-level virtualization, the virtualization layer 308 may represent a container engine running on top of (or integrated into) an operating system, and it allows for the creation of multiple software containers 304A-304R (representing separate user space instances and also called virtualization engines, virtual private servers, or jails) that may each be used to execute a set of one or more applications; with full virtualization, the virtualization layer 308 represents a hypervisor (sometimes referred to as a virtual machine monitor (VMM)) or a hypervisor executing on top of a host operating system, and the software containers 304A-304R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 328 is executed within the software container 304A on the virtualization layer 308. In electronic devices where compute virtualization is not used, the instance 306 on top of a host operating system is executed on the “bare metal” electronic device 300. The instantiation of the instance 306, as well as the virtualization layer 308 and software containers 304A-304R if implemented, are collectively referred to as software instance(s) 302.

Alternative implementations of an electronic device may have numerous variations from that described above. For example, customized hardware and/or accelerators might also be used in an electronic device.

FIG. 3B is a block diagram of a deployment environment according to some example implementations. A system 340 includes hardware (e.g., a set of one or more server devices) and software to provide service(s) 342, including a consolidated order manager. In some implementations the system 340 is in one or more datacenter(s). These datacenter(s) may be: 1) first party datacenter(s), which are datacenter(s) owned and/or operated by the same entity that provides and/or operates some or all of the software that provides the service(s) 342; and/or 2) third-party datacenter(s), which are datacenter(s) owned and/or operated by one or more different entities than the entity that provides the service(s) 342 (e.g., the different entities may host some or all of the software provided and/or operated by the entity that provides the service(s) 342). For example, third-party datacenters may be owned and/or operated by entities providing public cloud services.

The system 340 is coupled to user devices 380A-380S over a network 382. The service(s) 342 may be on-demand services that are made available to one or more of the users 384A-384S working for one or more entities other than the entity which owns and/or operates the on-demand services (those users sometimes referred to as outside users) so that those entities need not be concerned with building and/or maintaining a system, but instead may make use of the service(s) 342 when needed (e.g., when needed by the users 384A-384S). The service(s) 342 may communicate with each other and/or with one or more of the user devices 380A-380S via one or more APIs (e.g., a REST API). In some implementations, the user devices 380A-380S are operated by users 384A-384S, and each may be operated as a client device and/or a server device. In some implementations, one or more of the user devices 380A-380S are separate ones of the electronic device 300 or include one or more features of the electronic device 300.

In some implementations, the system 340 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 340 is a multi-tenant cloud computing architecture supporting multiple services, such as one or more of the following types of services: Customer relationship management (CRM); Configure, price, quote (CPQ); Business process modeling (BPM); Customer support; Marketing; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of Things (IoT); Industry-specific; Artificial intelligence (AI); Application marketplace (“app store”); Data modeling; Security; and Identity and access management (IAM). For example, system 340 may include an application platform 344 that enables PAAS for creating, managing, and executing one or more applications developed by the provider of the application platform 344, users accessing the system 340 via one or more of user devices 380A-380S, or third-party application developers accessing the system 340 via one or more of user devices 380A-380S.

In some implementations, one or more of the service(s) 342 may use one or more multi-tenant databases 346, as well as system data storage 350 for system data 352 accessible to system 340. In certain implementations, the system 340 includes a set of one or more servers that are running on server electronic devices and that are configured to handle requests for any authorized user associated with any tenant (there is no server affinity for a user and/or tenant to a specific server). The user devices 380A-380S communicate with the server(s) of system 340 to request and update tenant-level data and system-level data hosted by system 340, and in response the system 340 (e.g., one or more servers in system 340) automatically may generate one or more Structured Query Language (SQL) statements (e.g., one or more SQL queries) that are designed to access the desired information from the multi-tenant database(s) 346 and/or system data storage 350.

In some implementations, the service(s) 342 are implemented using virtual applications dynamically created at run time responsive to queries from the user devices 380A-380S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 360 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 344 includes an application setup mechanism that supports application developers' creation and management of applications, which may be saved as metadata by save routines. Invocations to such applications, including the framework for modeling heterogeneous feature sets, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 382 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 340 and the user devices 380A-380S.

Each user device 380A-380S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 340. For example, the user interface device can be used to access data and applications hosted by system 340, and to perform searches on stored data, and otherwise allow one or more of users 384A-384S to interact with various GUI pages that may be presented to the one or more of users 384A-384S. User devices 380A-380S might communicate with system 340 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 380A-380S might include an HTTP client, commonly referred to as a “browser,” for sending and receiving HTTP messages to and from server(s) of system 340, thus allowing users 384A-384S of the user devices 380A-380S to access, process and view information, pages and applications available to it from system 340 over network 382.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A computer-implemented method for predicting future performance degradation of at least one of a plurality of features utilized by at least one of a plurality of customers, the method comprising:
collecting, in a raw format, metadata associated with a plurality of features utilized by a plurality of customers, the metadata comprising a plurality of loglines and at least one logline being associated with an execution of a feature by a customer comprising metrics associated with the execution;
identifying, for at least one feature, a set of metrics indicating performance of the at least one feature;
identifying and transforming, based on the set of metrics, a subset of metadata;
identifying, based on the set of metrics, a data model;
applying the data model to the subset of metadata to predict future performance of the at least one feature for at least one of the plurality of customers; and
in response to predicting future performance of the at least one feature for at least one of the plurality of customers exceeds a threshold, generating an alert indicating the at least one of the plurality of customers may experience performance degradation of the at least one feature.

2. The computer-implemented method of claim 1, wherein the plurality of features includes one or more features selected from the list comprising:
calendar sync;
high velocity sales;
territory management; and
forecasting.

3. The computer-implemented method of claim 1, wherein the set of metrics includes one or more metrics selected from the list comprising:
an average transaction age;
a time preparing a transaction;
a time processing a transaction;
a completed task status; and
a number of requests triggered per time period.

4. The computer-implemented method of claim 1, wherein the data model is selected from the list comprising:
an open source data model;
a customized data model; and
a third-party derived data model.

5. The computer-implemented method of claim 1, wherein identifying and transforming, based on the set of metrics, the subset of metadata comprises:
identifying the subset of metadata to include one or more loglines, the one or more loglines including one or more metrics of the set of metrics; and
transforming the subset of metadata such that the one or more loglines comprise the set of metrics and an indication of an associated customer.

6. The computer-implemented method of claim 1, further comprising:
identifying, for at least one other feature, a second set of metrics indicating performance of the at least one other feature;
identifying and transforming, based on the second set of metrics, a second subset of metadata;
identifying, based on the second set of metrics, a second data model;
applying the second data model to the second subset of metadata to predict future performance of the at least one other feature for at least one of the plurality of customers; and
in response to predicting future performance of the at least one other feature for at least one of the plurality of customers exceeds a threshold, generating an alert indicating the at least one of the plurality of customers may experience performance degradation of the at least one other feature.

7. A non-transitory machine-readable storage medium that provides instructions that, if executed by a processor, are configurable to cause the processor to perform operations comprising:
collecting, in a raw format, metadata associated with a plurality of features utilized by a plurality of customers, the metadata comprising a plurality of loglines and at least one logline being associated with an execution of a feature by a customer comprising metrics associated with the execution;
identifying, for at least one feature, a set of metrics indicating performance of the at least one feature;
identifying and transforming, based on the set of metrics, a subset of metadata;
identifying, based on the set of metrics, a data model;
applying the data model to the subset of metadata to predict future performance of the at least one feature for at least one of the plurality of customers; and
in response to predicting future performance of the at least one feature for at least one of the plurality of customers exceeds a threshold, generating an alert indicating the at least one of the plurality of customers may experience performance degradation of the at least one feature.

8. The non-transitory machine-readable storage medium of claim 7, wherein the plurality of features includes one or more features selected from the list comprising:
calendar sync;
high velocity sales;
territory management; and
forecasting.

9. The non-transitory machine-readable storage medium of claim 7, wherein the set of metrics includes one or more metrics selected from the list comprising:
an average transaction age;
a time preparing a transaction;
a time processing a transaction;
a completed task status; and
a number of requests triggered per time period.

10. The non-transitory machine-readable storage medium of claim 7, wherein the data model is selected from the list comprising:
an open source data model;
a customized data model; and
a third-party derived data model.

11. The non-transitory machine-readable storage medium of claim 7, wherein identifying and transforming, based on the set of metrics, the subset of metadata comprises:
identifying the subset of metadata to include one or more loglines, the one or more loglines including one or more metrics of the set of metrics; and
transforming the subset of metadata such that the one or more loglines comprise the set of metrics and an indication of an associated customer.

12. The non-transitory machine-readable storage medium of claim 7, wherein the operations further comprise:
identifying, for at least one other feature, a second set of metrics indicating performance of the at least one other feature;
identifying and transforming, based on the second set of metrics, a second subset of metadata;
identifying, based on the second set of metrics, a second data model;
applying the second data model to the second subset of metadata to predict future performance of the at least one other feature for at least one of the plurality of customers; and
in response to predicting future performance of the at least one other feature for at least one of the plurality of customers exceeds a threshold, generating an alert indicating the at least one of the plurality of customers may experience performance degradation of the at least one other feature.

13. An apparatus comprising:
a processor; and
a non-transitory machine-readable storage medium that provides instructions that, if executed by a processor, are configurable to cause the processor to perform operations comprising:
collecting, in a raw format, metadata associated with a plurality of features utilized by a plurality of customers, the metadata comprising a plurality of loglines and at least one logline being associated with an execution of a feature by a customer comprising metrics associated with the execution;
identifying, for at least one feature, a set of metrics indicating performance of the at least one feature;
identifying and transforming, based on the set of metrics, a subset of metadata;
identifying, based on the set of metrics, a data model;
applying the data model to the subset of metadata to predict future performance of the at least one feature for at least one of the plurality of customers; and
in response to predicting future performance of the at least one feature for at least one of the plurality of customers exceeds a threshold, generating an alert indicating the at least one of the plurality of customers may experience performance degradation of the at least one feature.

14. The apparatus of claim 13, wherein the plurality of features includes one or more features selected from the list comprising:
calendar sync;
high velocity sales;
territory management; and
forecasting.

15. The apparatus of claim 13, wherein the set of metrics includes one or more metrics selected from the list comprising:
an average transaction age;
a time preparing a transaction;
a time processing a transaction;
a completed task status; and
a number of requests triggered per time period.

16. The apparatus of claim 13, wherein the data model is selected from the list comprising:
an open source data model;
a customized data model; and
a third-party derived data model.

17. The apparatus of claim 13, wherein identifying and transforming, based on the set of metrics, the subset of metadata comprises:
identifying the subset of metadata to include one or more loglines, the one or more loglines including one or more metrics of the set of metrics; and
transforming the subset of metadata such that the one or more loglines comprise the set of metrics and an indication of an associated customer.

18. The apparatus of claim 13, wherein the operations further comprise:
identifying, for at least one other feature, a second set of metrics indicating performance of the at least one other feature;
identifying and transforming, based on the second set of metrics, a second subset of metadata;
identifying, based on the second set of metrics, a second data model;
applying the second data model to the second subset of metadata to predict future performance of the at least one other feature for at least one of the plurality of customers; and
in response to predicting future performance of the at least one other feature for at least one of the plurality of customers exceeds a threshold, generating an alert indicating the at least one of the plurality of customers may experience performance degradation of the at least one other feature.
